(19) United States
(12) Patent Application Publication
(10) Pub. No.: US 2025/0269919 A1
(43) Pub. Date: Aug. 28, 2025

(54) CONTROL DEVICE, SYSTEM, MOUNTING DEVICE, AND MOVING OBJECT

(71) Applicant: TOYOTA JIDOSHA KABUSHIKI KAISHA, Toyota-shi (JP)

(72) Inventors: Kento IWAHORI, Nagoya-shi (JP); Daiki YOKOYAMA, Miyoshi-shi (JP); Jyunya KATOU, Toyota-shi (JP)

(73) Assignee: TOYOTA JIDOSHA KABUSHIKI KAISHA, Toyota-shi (JP)

(21) Appl. No.: 19/034,931

(22) Filed: Jan. 23, 2025

(30) Foreign Application Priority Data
Feb. 27, 2024 (JP) 2024-027141

(51) Int. Cl. B62D 65/18; B62D 65/02

(52) U.S. Cl. CPC B62D 65/18; B62D 65/024

(57) ABSTRACT

A control device controls mounting of a component on a moving object in a process of manufacturing the moving object, and comprises: an information acquiring unit that acquires first information that is information relating to unsuccessful mounting of the component by a mounting device to conduct on-the-move mounting that is mounting of the component on the moving object while the moving object is moving by unmanned driving; a first instructing unit that gives a first instruction for instructing deceleration or stop to the moving object if the first information is acquired; and a second instructing unit that gives a second instruction for instructing re-mounting to the mounting device after transmission of the first instruction. The re-mounting is mounting of the component on the moving object while the moving object is decelerated or stopped.

### CROSS REFERENCE TO RELATED APPLICATIONS

The present application claims priority from Japanese patent application No. P2024-027141 filed on Feb. 27, 2024, the disclosure of which is hereby incorporated in its entirety by reference into the present application.

### BACKGROUND

### Field

The present disclosure relates to a control device, a system, a mounting device, and a moving object.

### Related Art

There is a known technique by which a vehicle is driven in a driverless manner by remote control in a process of manufacturing the vehicle (Japanese Patent Application Publication (Translation of PCT Application) No. 2017-538619, for example).

In the process of manufacturing the vehicle, employing on-the-move mounting is examined by which a component is mounted on the vehicle in a moving state by controlling a robot. However, the above Patent Application Publication No. 2017-538619 does not give sufficient consideration to how to handle a situation in the event of failure of such on-the-move mounting. This problem is not only in the case of vehicles but is common to any type of moving object.

### SUMMARY

According to one aspect of the present disclosure, a control device is provided that controls mounting of a component on a moving object in a process of manufacturing the moving object. The control device comprises: an information acquiring unit that acquires first information that is information relating to unsuccessful mounting of the component by a mounting device to conduct on-the-move mounting that is mounting of the component on the moving object while the moving object is moving by unmanned driving; a first instructing unit that gives a first instruction for instructing deceleration or stop to the moving object if the first information is acquired; and a second instructing unit that gives a second instruction for instructing re-mounting to the mounting device after transmission of the first instruction. The re-mounting is mounting of the component on the moving object while the moving object is decelerated or stopped.

### BRIEF DESCRIPTION OF THE DRAWINGS

FIG. 1 is an explanatory view showing the configuration of a system according to a first embodiment;

FIG. 2 is an explanatory view showing the configuration of a vehicle according to the first embodiment;

FIG. 3 is an explanatory view showing the configuration of a server device according to the first embodiment;

FIG. 4 is an explanatory view showing the configuration of a mounting robot according to the first embodiment;

FIG. 5 is an explanatory view showing how the vehicle runs by unmanned driving in a factory;

FIG. 6 is a flowchart showing a processing procedure of running control over a vehicle 100 according to the first embodiment;

FIGS. 7 and 8 are flowcharts each showing a procedure of component mounting control according to the first embodiment;

FIG. 9 is an explanatory view showing the configuration of a mounting robot according to a second embodiment;

FIG. 10 is a block diagram showing the configuration of a system according to a third embodiment; and

FIG. 11 is a flowchart showing a processing procedure of running control over a vehicle according to the third embodiment.

### DETAILED DESCRIPTION

### A. First Embodiment

### A-1. System Configuration:

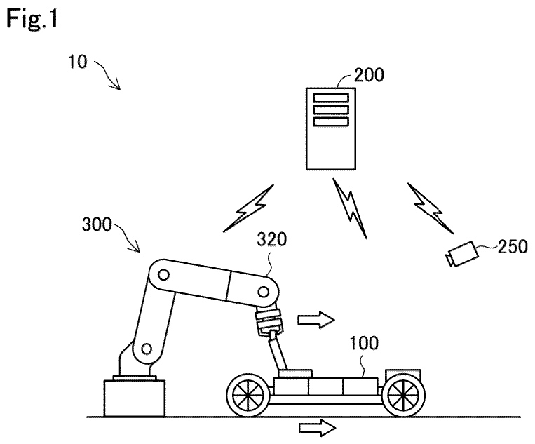

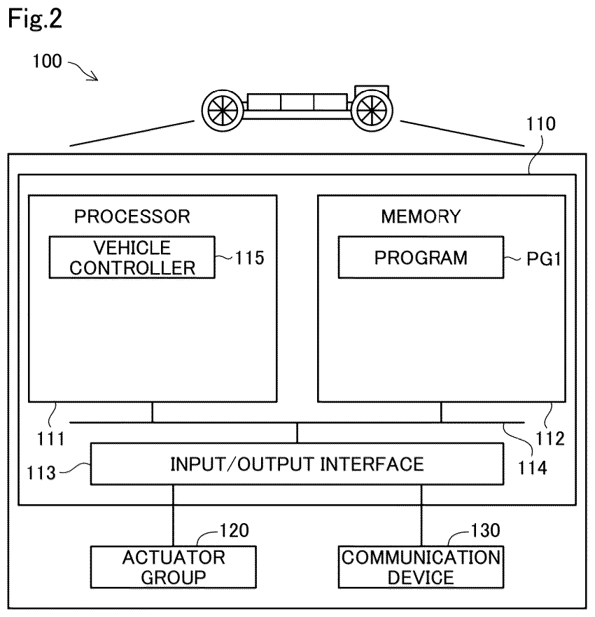

FIG. 1 is an explanatory view showing the configuration of a system 10 according to the first embodiment. System 10 is used in a factory KJ for manufacture of a vehicle 100 as a moving object, for example. In the present disclosure, the “moving object” means an object capable of moving, and is a vehicle or an electric vertical takeoff and landing aircraft (so-called flying-automobile), for example. The vehicle may be a vehicle to run with a wheel or may be a vehicle to run with a continuous track, and may be a passenger car, a truck, a bus, a two-wheel vehicle, a four-wheel vehicle, or a construction vehicle, for example. The vehicle includes a battery electric vehicle (BEV), a gasoline automobile, a hybrid automobile, and a fuel cell automobile. When the moving object is other than a vehicle, the term “vehicle” or “car” in the present disclosure is replaceable with a “moving object” as appropriate, and the term “run” is replaceable with “move” as appropriate.

System 10 includes a server device 200, at least one external sensor 250, and a mounting robot 300. The system 10 controls mounting of a component on the vehicle 100 in the factory KJ for manufacture of the vehicle 100. The vehicle 100 is configured to be capable of running by unmanned driving. Even when the vehicle 100 is being manufactured in a process of manufacturing the vehicle 100 itself, the vehicle 100 is still capable of running by unmanned driving. In the system 10, the mounting robot 300 conducts the work of mounting a component on the vehicle 100 running by unmanned driving. In the present embodiment, the vehicle 100 runs by unmanned driving while the vehicle 100 is in the state of a so-called platform.

To fulfill three functions including “run,” “turn,” and “stop” by unmanned driving, the vehicle 100 in the state of a platform may be required to include at least a control device for controlling running of the vehicle 100, and actuators such as a driving device, a steering device, and a braking device. If the vehicle 100 is to acquire information from outside for unmanned driving, the vehicle 100 may further include a communication device. Specifically, the vehicle 100 movable by unmanned driving may not have to be equipped with at least some of interior components such as a driver's seat and a dashboard, may not have to be equipped with at least some of exterior components such as a bumper and a fender, or may not have to be equipped with a bodyshell. In such cases, a remaining component such as a bodyshell may be mounted on the vehicle 100 before the vehicle 100 is shipped from the factory KJ, or a remaining component such as a bodyshell may be mounted on the vehicle 100 after the vehicle 100 is shipped from the factory KJ while the remaining component such as a bodyshell is not mounted on the vehicle 100. Each of components may be mounted on the vehicle 100 from any direction such as from above, from below, from the front, from the rear, from the right, or from the left. These components may be mounted from the same direction or from respective different directions.

In the present embodiment, “unmanned driving” means driving independent of driving operation by a passenger on-board the vehicle 100. “Driving operation” means operation relating to at least one of “run,” “turn,” and “stop” of the vehicle 100. Unmanned driving is realized by automatic or manual remote control using a device provided outside the vehicle 100, or by autonomous control by the vehicle 100. A passenger not involved in driving operation may be on-board the vehicle 100 running by unmanned driving. The passenger not involved in driving operation includes a person simply sitting in a driver's seat of the vehicle 100 and a person doing behavior different from driving operation, for example. The behavior different from driving operation includes work of mounting a component on the vehicle 100, inspection on the vehicle 100, and operation of switches provided in the vehicle 100, for example. Driving by driving operation by a passenger may be called “manned driving.”

The vehicle 100 is configured to be capable of running by unmanned driving. The “unmanned driving” means driving independent of running operation by a passenger. The running operation means operation relating to at least one of “run,” “turn,” and “stop” of the vehicle 100. Unmanned driving is realized by automatic remote control or manual remote control using a device provided outside the vehicle 100 or by autonomous control by the vehicle 100. A passenger not involved in running operation may be on-board a vehicle running by the unmanned driving. The passenger not involved in running operation includes a person simply sitting in a seat of the vehicle 100 and a person doing work such as assembly, inspection, or operation of switches different from running operation while on-board the vehicle 100. Driving by running operation by a passenger may also be called “manned driving.” In the present specification, the “remote control” includes “complete remote control” by which all motions of the vehicle 100 are completely determined from outside the vehicle 100, and “partial remote control” by which some of the motions of the vehicle 100 are determined from outside the vehicle 100. The “autonomous control” includes “complete autonomous control” by which the vehicle 100 controls a motion of the vehicle 100 autonomously without receiving any information from a device outside the vehicle 100, and “partial autonomous control” by which the vehicle 100 controls a motion of the vehicle 100 autonomously using information received from a device outside the vehicle 100.

A vehicle control device 110 is configured using a computer including a processor 111, a memory 112, an input/output interface 113, and an internal bus 114. The processor 111, the memory 112, and the input/output interface 113 are connected to each other via the internal bus 114 in a manner allowing bidirectional communication therebetween. An actuator group 120 and a communication device 130 are connected to the input/output interface 113. The processor 111 executes a program PG1 stored in memory 112, thereby realizing various functions including a function as a vehicle controller 115.

The vehicle controller 115 causes the vehicle 100 to run by controlling the actuator group 120. The vehicle controller 115 is capable of causing the vehicle 100 to run by controlling the actuator group 120 using a running control signal received from the server device 200. The running control signal is a control signal for causing the vehicle 100 to run. In the present embodiment, the running control signal includes the acceleration and rudder angle of the vehicle 100 as parameters. In other embodiments, the running control signal may include the speed of the vehicle 100 as a parameter instead of or in addition to the acceleration of the vehicle 100. When a passenger is on-board the vehicle 100, the vehicle controller 115 is capable of causing the vehicle 100 to run by controlling the actuator group 120 in response to driving operation by the passenger. Independently of whether a passenger is on-board the vehicle 100, the vehicle controller 115 is capable of causing the vehicle 100 to run by controlling the actuator group 120 in response to a running control signal received from the server device 200. The vehicle controller 115 corresponds to a “moving object controller” of the present disclosure.

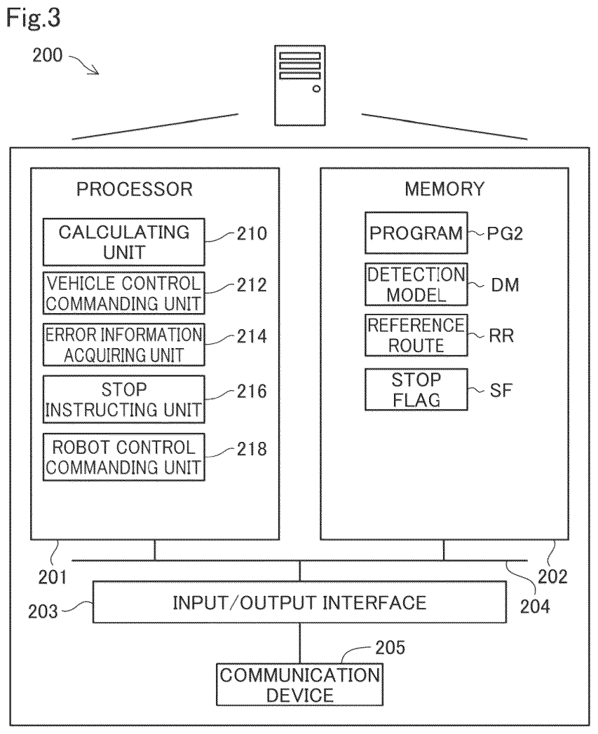

FIG. 3 is an explanatory view showing the configuration of the server device 200 according to the present embodiment. The server device 200 is configured using a computer including a processor 201, a memory 202, an input/output interface 203, and an internal bus 204. Processor 201, the memory 202, and the input/output interface 203 are connected to each other via the internal bus 204 in a manner allowing bidirectional communication therebetween. A communication device 205 for communicating with the vehicle 100 by radio communication is connected to the input/output interface 203. In the present embodiment, communication device 205 is capable of communicating with the external sensor 250 and the mounting robot 300 via wire communication or radio communication. The processor 201 executes a program PG2 stored in advance in the memory 202, thereby functioning as a calculating unit 210, a vehicle control commanding unit 212, an error information acquiring unit 214, a stop instructing unit 216, and a robot control commanding unit 218. The server device 200 corresponds to a “control device” of the present disclosure.

In the present embodiment, the calculating unit 210 calculates vehicle positional information using detection result output from the external sensor 250. The vehicle positional information contains information about the position and direction of the vehicle 100. The vehicle control commanding unit 212 generates a vehicle control command using the vehicle positional information. The vehicle control commanding unit 212 generates a running control signal mentioned above as the vehicle control command.

The error information acquiring unit 214 acquires mounting error information, and switches the state of a stop flag SF stored in memory 202 to either ON or OFF in response to the mounting error information. The “mounting error information” means information about mounting error. The “mounting error” means a state where, even after the mounting robot 300 makes motion of mounting a component, the component is not mounted properly on the vehicle 100. Specifically, the mounting error information means information indicating that the component has not been mounted successfully on the vehicle 100 by the mounting robot 300. In the present embodiment, the error information acquiring unit 214 acquires an error signal as the mounting error information output from the mounting robot 300, as will be described later. The “stop flag SF” means a flag representing a situation of the occurrence of mounting error in the system 10. A way in which the stop flag SF is switched will be described later in detail. The mounting error information corresponds to “first information” of the present disclosure. The error information acquiring unit 214 corresponds to an “information acquiring unit” of the present disclosure.

The stop instructing unit 216 transmits a stop signal for instructing stop to the vehicle 100 if the mounting error information is acquired. In the present embodiment, the stop signal is an emergency stop signal for instructing the vehicle 100 to be stopped emergently and may be generated independently of detection result from the external sensor 250. This allows the stop instructing unit 216 to instruct emergent stop of the vehicle 100 immediately in response to acquisition of the mounting error information independently of detection result from the external sensor 250. If the stop signal is received, the vehicle controller 115 controls the actuator group 120 to stop the vehicle 100. Specifically, the stop signal corresponds to a “first instruction” of the present disclosure and the stop instructing unit 216 corresponds to a “first instructing unit” of the present disclosure.

The robot control commanding unit 218 generates a motion control signal for causing the mounting robot 300 to make motion and transmits the motion control signal to the mounting robot 300. The mounting robot 300 having received the motion control signal, makes motion in response to the motion control signal. In the following description, the motion control signal for instructing the mounting robot 300 to make motion of mounting a component on the vehicle 100 will also be called a “mounting instruction.” The motion control signal of the present embodiment is generated as a signal for making a specific command for a stroke of each part forming the mounting robot 300. The robot control commanding unit 218 of the present embodiment corresponds to a “motion control signal generating unit.”

In the present embodiment, the robot control commanding unit 218 generates the motion control signal for the mounting robot 300 in such a manner as to cause the mounting robot 300 to conduct mounting work while the vehicle 100 is in a state of moving by unmanned driving. In the following description, such mounting of a component on the vehicle 100 moving by unmanned driving will also be called “on-the-move mounting.” According to the on-the-move mounting, as work is conducted while the vehicle 100 is running, it is possible to prevent loss in manufacturing speed during implementation of the work. The robot control commanding unit 218 generates the motion control signal in such a manner as to mount a component on a predetermined position of the vehicle 100 in a predetermined direction while the vehicle 100 is running and to achieve a zero relative speed during the mounting between the vehicle 100 and the component in a direction parallel to a mounting target surface of the vehicle 100.

The external sensor 250 is located outside the vehicle 100. The external sensor 250 is used for detecting the position and direction of the vehicle 100. In the present embodiment, the external sensor 250 is a camera installed at the factory KJ. The external sensor 250 includes a communication device not shown in the drawings and is capable of communicating with the server device 200 via wire communication or radio communication. The external sensor 250 is not limited to the camera but may be LiDAR, for example.

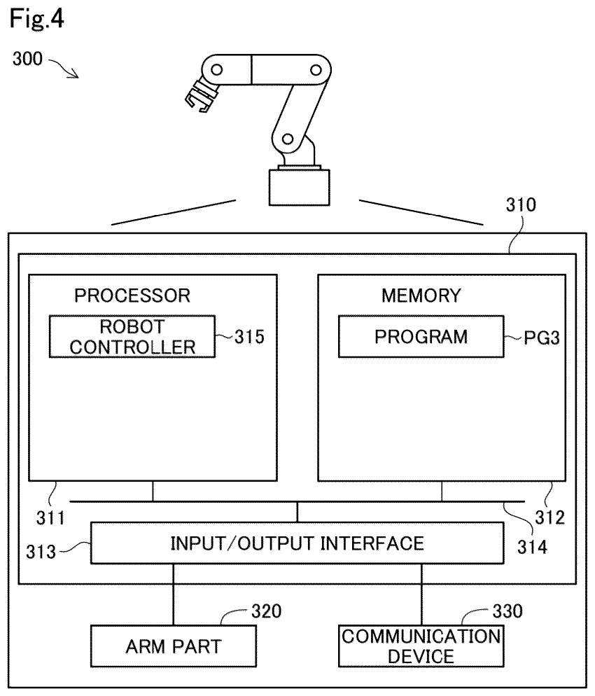

FIG. 4 is an explanatory view showing the configuration of the mounting robot 300 according to the present embodiment. The mounting robot 300 includes a robot control device 310, an arm part 320, and a communication device 330. In the present embodiment, the robot control device 310 controls each part of the mounting robot 300. The arm part 320 is composed of a vertical articulated type robot arm. The arm part 320 has a tip equipped with an end effector for gripping a component. In the present embodiment, the end effector is configured to put a component therein. The communication device 330 is capable of communicating with the server device 200 via wire communication or radio communication. The arm part 320 is not limited to a vertical articulated type robot arm but may be composed of a horizontal articulated type robot arm, an orthogonal type robot arm, or a parallel link type robot arm, for example. The end effector may be configured to cause a component to stick thereto instead of being configured to put the component therein. While not shown in the drawings, the mounting robot 300 includes sensors for detecting a motor load for driving the arm part 320, impact force applied during component mounting, etc. The mounting robot 300 corresponds to a “mounting device” of the present disclosure.

The robot control device 310 is configured using a computer including a processor 311, a memory 312, an input/output interface 313, and an internal bus 314. The processor 311, the memory 312, and the input/output interface 313 are connected to each other via the internal bus 314 in a manner allowing bidirectional communication therebetween. The arm part 320 and the communication device 330 are connected to the input/output interface 313.

In the present embodiment, the processor 311 executes a program PG3 stored in advance in memory 312, thereby functioning as a robot controller 315. The robot controller 315 receives a motion control signal and controls each part of the mounting robot 300 including the arm part 320 in response to the motion control signal. The robot controller 315 corresponds to a “receiving unit” and a “device controller” of the present disclosure.

The robot controller 315 outputs an error signal on the occurrence of error in mounting a component on the vehicle 100. The mounting error may occur in a case where a component mounting position is not set properly or error is generated in detecting the position of the vehicle 100, for example. If a motor load or impact force applied during component mounting is not within a threshold range defined in advance, for example, the robot controller 315 determines that the mounting error has occurred and outputs the error signal.

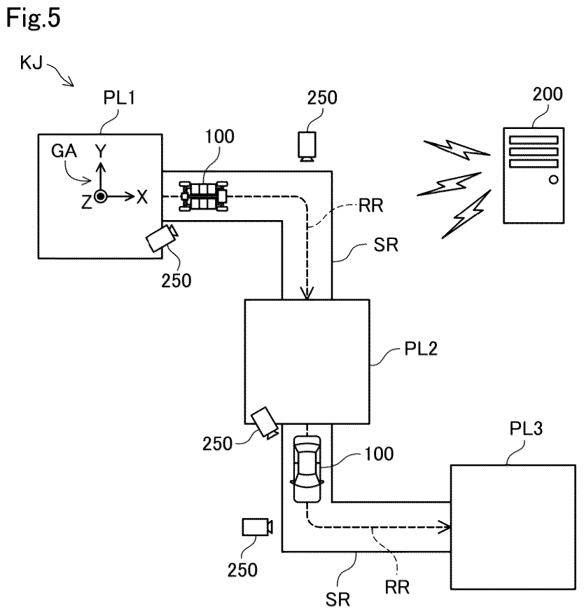

FIG. 5 is an explanatory view showing how the vehicle 100 runs by unmanned driving in the factory KJ. In the present embodiment, the factory KJ has a first place PL1, a second place PL2, and a third place PL3. The first place PL1, the second place PL2, and the third place PL3 are connected to each other via a track SR along which the vehicle 100 is capable of running. The factory KJ is equipped with a plurality of the external sensors 250 along the track SR.

The first place PL1 is a place where work of assembling the vehicle 100 is

conducted. The vehicle 100 having been assembled at the first place PL1 becomes capable of running by unmanned driving, in other words, becomes capable of fulfilling the three functions including “run,” “turn,” and “stop” by unmanned driving. In the present embodiment, the vehicle 100 having been assembled at the first place PL1 is in the state of a platform. The vehicle 100 moves from the first place PL1 to the second place PL2 by unmanned driving.

The second place PL2 is a place where further work of mounting a component on the vehicle 100 is conducted. The mounting robot 300 is located in the second place PL2. A component to be mounted at the second place PL2 is a vehicle body component, an interior component such as a seat, a headlamp, or a wiper, for example. In the present embodiment, the vehicle 100 with the component mounted at the second place PL2 is in the state of a finished vehicle. The vehicle 100 moves from the second place PL2 to the third place PL3 by unmanned driving.

The third place PL3 is a place where work of inspecting the vehicle 100 is conducted. The vehicle 100 having passed the inspection at the third place PL3 is shipped from the factory KJ. The vehicle 100 is not required to be in the state of a finished vehicle when shipped from the factory KJ. Specifically, there may be a component yet to be mounted on the vehicle 100 when the vehicle 100 is shipped from the factory KJ. In this case, the component yet to be mounted may be mounted on the vehicle 100 after the vehicle 100 is shipped from the factory KJ.

### A-2. Running Control:

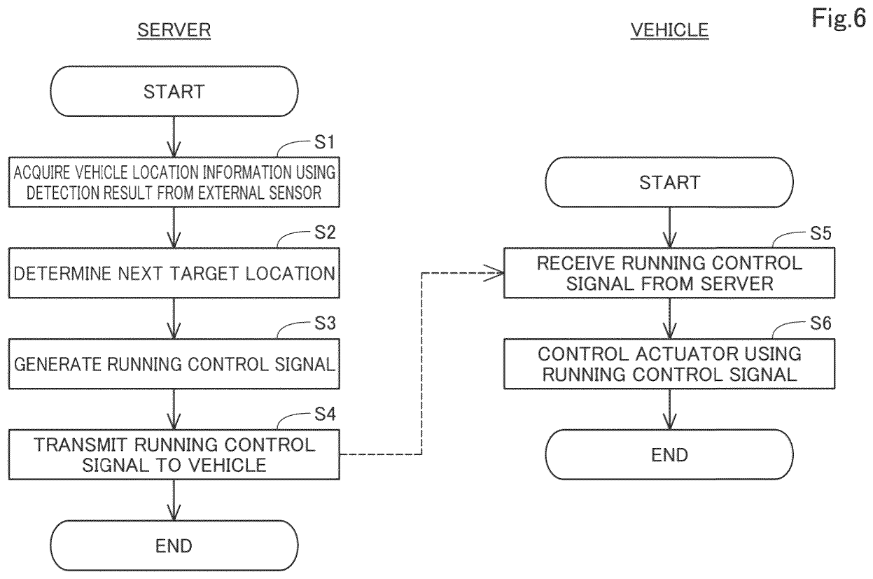

FIG. 6 is a flowchart showing a processing procedure for running control of the vehicle 100 in the first embodiment. In step S1, the calculating unit 210 acquires vehicle location information of the vehicle 100 using detection result output from an external sensor 250. The external sensor is located outside the vehicle 100. The vehicle location information is locational information as a basis for generating a running control signal. In the present embodiment, the vehicle location information includes the location and orientation of the vehicle 100 in a global coordinate system GA of the factory KJ. Specifically, in step S1, the calculating unit 210 acquires the vehicle location information using the captured image acquired from the camera as the external sensor 250.

More specifically, in step S1, the calculating unit 210 for example, determines the outer shape of the vehicle 100 from the captured image, calculates the coordinates of a positioning point of the vehicle 100 in a coordinate system of the captured image, namely, in a local coordinate system, and converts the calculated coordinates to coordinates in the global coordinate system GA, thereby acquiring the location of the vehicle 100. The outer shape of the vehicle 100 in the captured image may be detected by inputting the captured image DM to a detection model using artificial intelligence, for example. The detection model DM is prepared in the system 10 or outside the system 10. The detection model is stored in advance in a memory 202 of the server 200, for example. An example of the detection model DM is a learned machine learning model that was learned so as to realize either semantic segmentation or instance segmentation. For example, a convolution neural network (CNN) learned through supervised learning using a learning dataset is applicable as this machine learning model. The learning dataset contains a plurality of training images including the vehicle 100, and a label showing whether each region in the training image is a region indicating the vehicle 100 or a region indicating a subject other than the vehicle 100, for example. In training the CNN, a parameter for the CNN is preferably updated through backpropagation in such a manner as to reduce error between output result obtained by the detection model and the label. The calculating unit 210 can acquire the orientation of the vehicle 100 through estimation based on the direction of a motion vector of the vehicle 100 detected from change in location of a feature point of the vehicle 100 between frames of the captured images using optical flow process, for example.

In step S2, the vehicle control commanding unit 212 determines a target location to which the vehicle 100 is to move next. In the present embodiment, the target location is expressed by X, Y, and Z coordinates in the global coordinate system GA. The memory 202 of the server 200 contains a reference route RR stored in advance as a route along which the vehicle 100 is to run. The route is expressed by a node indicating a departure place, a node indicating a way point, a node indicating a destination, and a link connecting nodes to each other. The vehicle control commanding unit 212 determines the target location to which the vehicle 100 is to move next using the vehicle location information and the reference route RR. The vehicle control commanding unit 212 determines the target location on the reference route RR ahead of a current location of the vehicle 100.

In step S3, the vehicle control commanding unit 212 generates a running control signal for causing the vehicle 100 to run toward the determined target location. The vehicle control commanding unit 212 calculates a running speed of the vehicle 100 from transition of the location of the vehicle 100 and makes comparison between the calculated running speed and a target speed of the vehicle 100 determined in advance. If the running speed is lower than the target speed, the vehicle control commanding unit 212 generally determines an acceleration in such a manner as to accelerate the vehicle 100. If the running speed is higher than the target speed as, the vehicle control commanding unit 212 generally determines an acceleration in such a manner as to decelerate the vehicle 100. If the vehicle 100 is on the reference route RR, the vehicle control commanding unit 212 determines a steering angle and an acceleration in such a manner as to prevent the vehicle 100 from deviating from the reference route. If the vehicle 100 is not on the reference route RR, in other words, if the vehicle 100 deviates from the reference route RR, the server 200 determines a steering angle and an acceleration in such a manner as to return the vehicle 100 to the reference route.

In step S4, the vehicle control commanding unit 212 transmits the generated running control signal to the vehicle 100. The vehicle control commanding unit 212 repeats the acquisition of vehicle location information, the determination of a target location, the generation of a running control signal, the transmission of the running control signal, and others in a predetermined cycle.

In step S5, the vehicle controller 115 receives the running control signal transmitted from the server 200. In step S6, the vehicle controller 115 controls an actuator group 120 using the received running control signal, thereby causing the vehicle 100 to run at the acceleration and the steering angle indicated by the running control signal. The vehicle controller 115 repeats the reception of a running control signal and the control over the actuator group 120 in a predetermined cycle. According to the system 10 in the present embodiment, it becomes possible to move the vehicle 100 without using a transport unit such as a crane or a conveyor.

### A-3. Component Mounting Control:

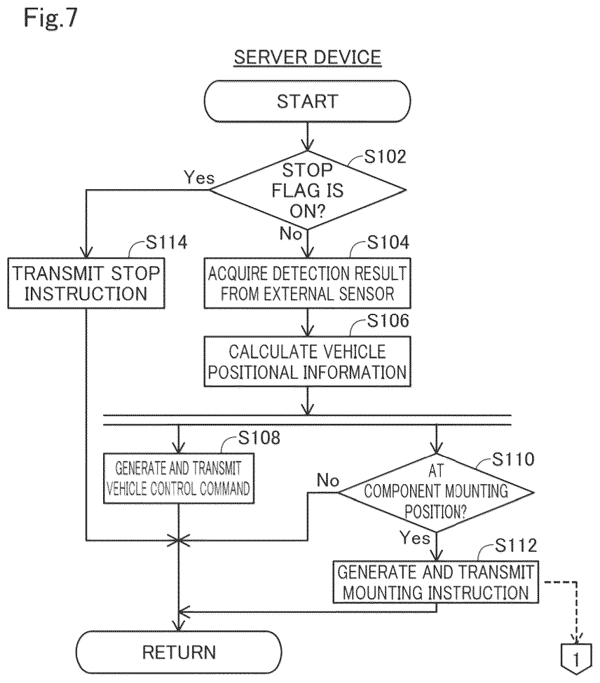

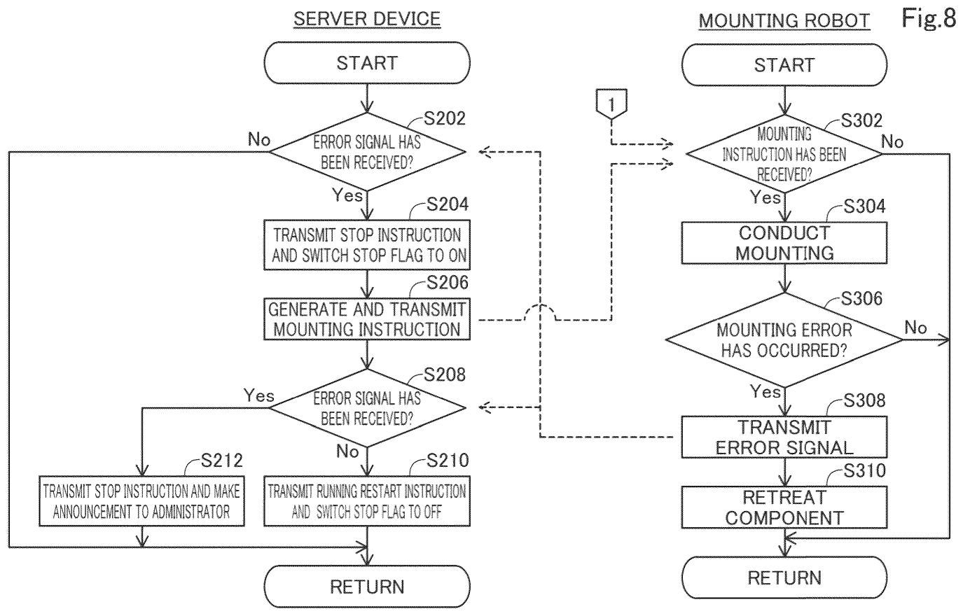

FIGS. 7 and 8 are flowcharts each showing a procedure of component mounting control according to the first embodiment. In the present embodiment, the above-described running control is performed as basic control and the control mentioned herein is performed in combination with this running control. The control shown in FIG. 7 and the control shown in FIG. 8 are started when the system 10 is brought into an operating state and are performed repeatedly in parallel with each other while the system 10 is operating.

The component mounting control shown in FIG. 7 will be described. As shown in FIG. 7, steps from step S102 to step S114 are performed by the server device 200. In step S102, the stop instructing unit 216 judges whether the state of the stop flag SF is ON. If the state of the stop flag SF is judged to be ON (step S102: Yes), the stop instructing unit 216 transmits a stop instruction to the vehicle 100 in step S114. Then, step S102 is performed again.

If the state of the stop flag SF is judged not to be ON (step S102: No), in other words, if the state of the stop flag SF is OFF, the calculating unit 210 acquires detection result from the external sensor 250 in step S104. Then, in step S106, the calculating unit 210 calculates vehicle positional information using the detection result from the external sensor 250.

In step S108, the vehicle control commanding unit 212 generates a vehicle control command using the vehicle positional information, and transmits the vehicle control command to the vehicle 100. Next, step S102 described above is performed again. In step S110, the robot control commanding unit 218 judges whether the vehicle 100 is at a component mounting position set in advance. The “component mounting position” means a position set in advance as a position where the mounting robot 300 is to start mounting of a component on the vehicle 100 in a process of manufacturing the vehicle 100.

If the vehicle 100 is judged to be at the component mounting position (step S110: Yes), the robot control commanding unit 218 generates a mounting instruction and transmits the mounting instruction to the mounting robot 300 in step S112. Then, step S102 described above is performed again.

If the vehicle 100 is judged not to be at the component mounting position (step S110: No), step S102 is performed again. In other words, if the vehicle 100 has not yet reached the component mounting position, running control over the vehicle 100 toward the component mounting position is performed continuously. Then, step S102 described above is performed again.

The component mounting control shown in FIG. 8 will be described. The control shown in Fig, 8 is performed in parallel with the above-described control shown in FIG. 7. As shown in FIG. 8, steps from step S202 to step S212 are performed by the server device 200, and steps from step S302 to step S310 are performed by the mounting robot 300.

In step S202 shown in FIG. 8, the error information acquiring unit 214 judges whether an error signal has been received. If it is judged that an error signal has not been received (step S202: No), the error information acquiring unit 214 performs step S202 repeatedly.

If it is judged that an error signal has been received (step S202: Yes), the stop instructing unit 216 transmits a stop signal to the vehicle 100 and the error information acquiring unit 214 switches the state of the stop flag SF to ON in step S204.

In step S206, the robot control commanding unit 218 generates a mounting instruction and transmits the mounting instruction to the mounting robot 300. Specifically, in the present embodiment, in the event of failure of the on-the-move mounting, the vehicle 100 is stopped and then the robot control commanding unit 218 instructs mounting of a component on the stopped vehicle 100 (hereinafter also called “re-mounting”). Specifically, the mounting instruction in this step corresponds to a “second instruction” of the present disclosure and the robot control commanding unit 218 corresponds to a “second instructing unit” of the present disclosure. In the following description, like the re-mounting control performed in this step, mounting of a component on the stopped vehicle 100 will also be called “stopped mounting.”

In step S208, the stop instructing unit 216 judges whether an error signal has been received. If it is judged that an error signal has not been received (step S208: No), the vehicle control commanding unit 212 transmits a running restart instruction for instructing restart of running to the vehicle 100 and the error information acquiring unit 214 switches the state of the stop flag SF to OFF in step S210.

If it is judged that an error signal has been received (step S208: Yes), the vehicle control commanding unit 212 transmits a stop instruction to the vehicle 100, in other words, instructs the vehicle 100 to continue the stopped state, and makes announcement to an administrator. The “administrator” mentioned herein is not limited to a person responsible for overall management of the system 10 but includes a worker to conduct restoration work on the occurrence of any abnormality at the system 10 and a worker conducting work near the component mounting step. By continuing the stopped state of the vehicle 100 and making the announcement to the administrator, it becomes possible to suppress prolongation of a situation where abnormality has occurred at the system 10 and manufacture of the vehicle 100 is interrupted.

The following describes the control by the mounting robot 300. In step S302, the robot controller 315 judges whether a mounting instruction has been received. If it is judged that a mounting instruction has not been received (step S302: No), the robot controller 315 performs step S302 repeatedly.

If it is judged that a mounting instruction has been received (step S302: Yes), the robot controller 315 conducts mounting of a component on the vehicle 100 in step S304.

In step S306, the robot controller 315 judges whether mounting error has occurred. If it is judged that mounting error has not occurred (step S306: No), in other words, if the on-the-move mounting on the vehicle 100 has been conducted successfully, step S302 described above is performed again.

If it is judged that mounting error has occurred (step S306: Yes), the robot controller 315 transmits an error signal to the server device 200 in step S308.

In step S310, the robot controller 315 retreats the component. More specifically, the robot controller 315 moves the component to a position where the component does not interfere with the vehicle 100. Then, step S302 described above is performed again.

In the system 10 of the above-described embodiment, if a component has not been mounted successfully on the vehicle 100 by the on-the-move mounting, a stop instruction is transmitted to the vehicle 100 and a re-mounting instruction is transmitted to the mounting robot 300. Thus, even if the component has not been mounted successfully on the vehicle 100 by the on-the-move mounting, it is still possible to attempt re-mounting of the component while a difficulty level in component mounting is reduced by stopping the vehicle 100. By doing so, it becomes possible to mount the component properly on the vehicle 100.

If the component has been mounted successfully by the re-mounting control, running is restarted. This makes it possible to suppress the extension of time required for manufacturing the vehicle 100, compared to a case where the stopped state is kept continuously.

The server device 200 includes the robot control commanding unit 218 that generates a motion control signal and transmits the generated motion control signal to the mounting robot 300. This makes it possible to prevent the control on the side of the mounting robot 300 from growing complicated.

### B. Second Embodiment

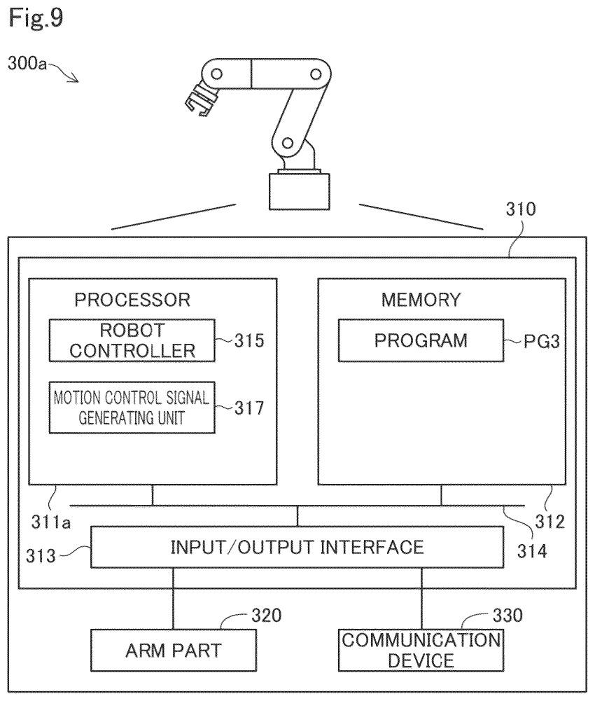

FIG. 9 is an explanatory view showing the configuration of a mounting robot 300a according to a second embodiment. The mounting robot 300a of the second embodiment differs from the mounting robot 300 of the first embodiment in that it includes a processor 311a further functioning as a motion control signal generating unit 317 as well as functioning as the robot controller 315. The other configuration of the mounting robot 300a of the second embodiment is the same as that of the mounting robot 300 of the first embodiment. Thus, a common structure will be given the same sign and detailed description thereof will be omitted.

The motion control signal generating unit 317 receives a mounting instruction from the robot control commanding unit 218 of the server device 200 and generates a motion control signal. In the present embodiment, the mounting instruction received from the robot control commanding unit 218 may be a signal for only instructing the mounting robot 300 to start component mounting control. In response to receipt of this mounting instruction as a trigger, the motion control signal generating unit 317 identifies a position of mounting of a component on the vehicle 100 using detection result from a sensor not shown in the drawings that is a camera belonging to the mounting robot 300a, for example, and generates the motion control signal autonomously. In the present embodiment, the robot controller 315 controls each part of the mounting robot 300a including the arm part 320 in response to the motion control signal generated by the motion control signal generating unit 317.

In system 10 including the mounting robot 300a of the second embodiment described above, the mounting robot 300a includes the motion control signal generating unit 317. This allows the mounting robot 300a to be controlled autonomously using a motion control signal generated by itself. Thus, it becomes unnecessary for the server device 200 to perform a process for controlling the mounting robot 300a, making it possible to prevent the control on the side of the server device 200 from growing complicated.

### C. Third Embodiment

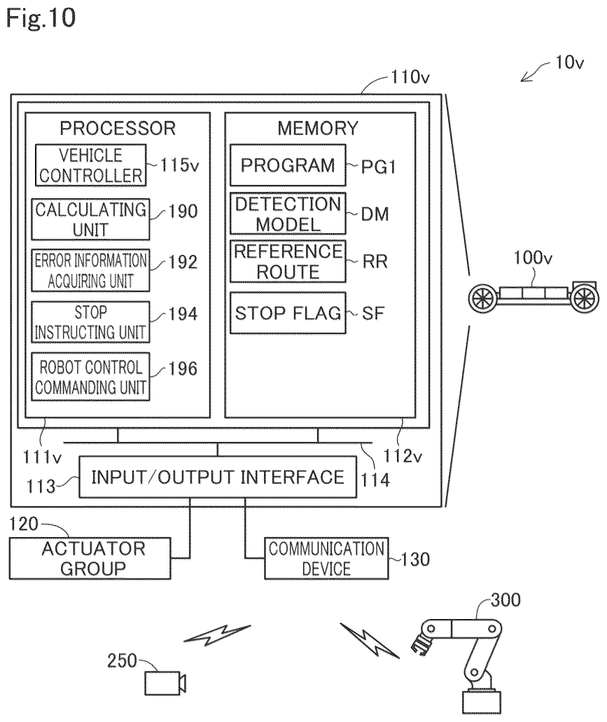

FIG. 10 is a block diagram showing the configuration of a system 10v according to a third embodiment. In the present embodiment, the system 10v differs from that of the first embodiment in that it does not include the server device 200 and it includes a vehicle control device 110v belonging to a vehicle 100v. The vehicle 100v of the present embodiment is capable of running by autonomous control by the vehicle 100v. The other configuration is the same as that of the first embodiment unless specified otherwise.

In the present embodiment, a processor 111v of the vehicle control device 110v executes a program PG1 stored in a memory 112v, thereby functioning as a vehicle controller 115v, a calculating unit 190, an error information acquiring unit 192, a stop instructing unit 194, and a robot control commanding unit 196. The vehicle controller 115v generates a running control signal using vehicle positional information, and outputs the generated running control signal to operate the actuator group 120. By doing so, the vehicle 100v becomes capable of running by autonomous control. In the present embodiment, memory 112v contains a detection model DM, a reference route RR, and a stop flag SF stored in advance in addition to the program PG1. The vehicle control device 110v of the third embodiment corresponds to the “control device” of the present disclosure. The vehicle controller 115v corresponds to the “moving object controller” of the present disclosure.

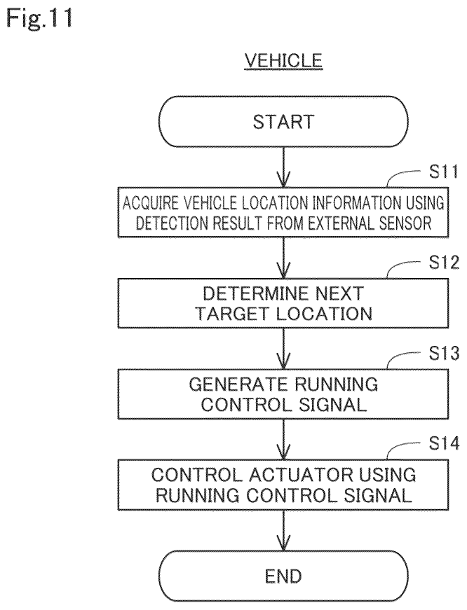

FIG. 11 is a flowchart showing a processing procedure for running control of the vehicle 100v in the third embodiment. In step S11, the processor 111v acquires vehicle location information using detection result output from the camera as an external sensor 250. In step S12, the processor 111v determines a target location to which the vehicle 100v is to move next. In step S13, the processor 111v generates a running control signal for causing the vehicle 100v to run to the determined target location. In step S14, the processor 111v controls an actuator group 120 using the generated running control signal, thereby causing the vehicle 100v to run by following a parameter indicated by the running control signal. The processor 111v repeats the acquisition of vehicle location information, the determination of a target location, the generation of a running control signal, and the control over the actuator group 120 in a predetermined cycle. According to the system 10v in the present embodiment, it is possible to cause the vehicle 100v to run by autonomous control without controlling the vehicle 100v remotely using the server 200.

Like in the above-described embodiments, even if a component has not been mounted successfully on the vehicle 100v by the on-the-move mounting, the system 10v of the present embodiment still makes it possible to attempt re-mounting of the component while a difficulty level in component mounting is reduced by stopping the vehicle 100v. By doing so, it becomes possible to mount the component properly on the vehicle 100v.

### D. Other Embodiments

(D1) In the above-described embodiments, if the state of the stop flag SF is ON, the stop instructing unit 216 transmits a stop instruction for instructing stop, in other words, a stop instruction for instructing to reduce a running speed of the vehicle 100 to 0. However, the present disclosure is not limited to this. The stop instructing unit 216 may transmit a deceleration instruction for instructing deceleration to an arbitrary speed that is a speed not leading to stop. Specifically, the stop instructing unit 216 generally instructs the vehicle 100 to be decelerated or stopped. The deceleration instruction corresponds to the “first instruction” of the present disclosure. According to this embodiment, if the on-the-move mounting has not been conducted successfully, it is also possible to conduct the on-the-move mounting on the vehicle 100 while the vehicle 100 is at a lower difficulty level in performing control in conjunction with the mounting robot 300 than in the case of the on-the-move mounting on the vehicle 100 running at a normal speed.

In the embodiment where the deceleration instruction is transmitted instead of the stop instruction, the vehicle control commanding unit 212 may give a running restart instruction for instructing acceleration from a decelerated state to a running speed in normal time in step S210 of the component mounting control shown in FIG. 8. The vehicle control commanding unit 212 may give a running restart instruction for instructing acceleration not only to a running speed in normal time but also to an arbitrary speed higher than a running speed on the occurrence of mounting error. In this embodiment, the vehicle 100 is accelerated if a component has been mounted successfully by the re-mounting control. This makes it possible to suppress the extension of time required for manufacturing the vehicle 100, compared to a case where the decelerated state is kept continuously.

(D2) In the above-described embodiments, if the state of the stop flag SF is ON, the stop instructing unit 216 transmits a stop instruction to the vehicle 100. However, the present disclosure is not limited to this. If the vehicle 100 is configured to be stopped automatically in response to application of a predetermined load or more, for example, the stop instructing unit 216 may not have to transmit a stop instruction to the vehicle 100. In this embodiment, the server device 200 may not have to include the stop instructing unit 216. This embodiment also achieves effects comparable to those of the above-described embodiments.

(D3) In the above-described embodiments, if the state of the stop flag SF is ON, the stop instructing unit 216 transmits an emergency stop signal as a stop instruction. However, the present disclosure is not limited to this. In addition to the emergency stop signal, a running control signal for instructing stop of the vehicle 100 may be transmitted from the vehicle control commanding unit 212. In this embodiment, the vehicle control commanding unit 212 corresponds to the “first instructing unit” of the present disclosure. This embodiment also achieves effects comparable to those of the above-described embodiments. Furthermore, as the running control signal for instructing stop is transmitted in addition to the emergency stop signal, it is possible to stop the vehicle 100 more reliably. The running control signal for instructing stop of the vehicle 100 may be transmitted instead of the emergency stop signal. In this embodiment, the server device 200 may not have to include the stop instructing unit 216.

(D4) In the above-described embodiments, the error information acquiring unit 214 acquires an error signal as mounting error information. However, the present disclosure is not limited to this. The error information acquiring unit 214 may acquire detection result from the external sensor 250 as mounting error information, for example. In this embodiment, the error information acquiring unit 214 may judge whether a component has been mounted successfully on the vehicle 100 by acquiring an image captured by a camera as the external sensor 250 and detecting the positions of the vehicle 100 and the component relative to each other in the captured image, for example. This embodiment also achieves effects comparable to those of the above-described embodiments.

(D5) In the above-described embodiments, the server device 200 performs control over the vehicle 100 as a component mounting target in response to whether the on-the-move mounting has been conducted successfully. However, the present disclosure is not limited to this. The server device 200 may further perform control over a vehicle other than the vehicle 100 as a component mounting target in response to whether the on-the-move mounting has been conducted successfully. If the on-the-move mounting ends in failure and the vehicle 100 as a component mounting target is stopped, the server device 200 may instruct a different vehicle running behind this vehicle 100 (hereinafter may also be called a “following vehicle”) to be stopped or decelerated in addition to performing step S204 described above. In this embodiment, it is possible to reduce a likelihood that running of a following moving object will be hindered as a result of shortening of a distance between a moving object on which the on-the-move mounting has not been conducted successfully and the following moving object.

If a component has not been mounted successfully even by the re-mounting, the server device 200 may instruct the following vehicle to be stopped or decelerated, in other words, may instruct the following vehicle to continue a stopped state or a decelerated state in addition to performing step S212 described above. In this embodiment, it is possible to restrict running of the vehicle 100 or the following moving object in a situation where the re-mounting has not been conducted successfully, namely, in a situation where some type of abnormality might occur.

If the on-the-move mounting ends in failure and the vehicle 100 as a component mounting target is stopped, the server device 200 may newly set a component mounting position for conducting the on-the-move mounting on the following vehicle, and a component mounting angle and a component mounting speed for mounting on the following vehicle. These new components mounting position, and component mounting angle and component mounting speed for mounting on the following vehicle may be determined by adding amounts of compensation defined in advance or may be determined using detection result from the external sensor 250, for example. This embodiment allows a way of the on-the-move mounting on the following vehicle to be changed in response to whether the on-the-move mounting has been conducted successfully on the preceding vehicle, making it possible to reduce a probability of failure of the on-the-move mounting on the following vehicle.

If the on-the-move mounting ends in failure and the vehicle 100 as a component mounting target is stopped, the server device 200 may conduct the stopped mounting on the following vehicle instead of the on-the-move mounting. In this embodiment, even if the on-the-move mounting ends in failure, it is still possible to attempt re-mounting of a component by the stopped mounting where a difficulty level in component mounting is lower than in the on-the-move mounting. This allows the component to be mounted properly on the vehicle 100.

(D6) In the above-described embodiments, the motion control signal generating unit 317 receives a mounting instruction from the robot control commanding unit 218 of the server device 200 and generates a motion control signal. However, the present disclosure is not limited to this. The motion control signal generating unit 317 may generate a motion control signal if the vehicle 100 is determined to be at a component mounting position using detection result from a sensor that may be a camera belonging to the mounting robot 300a, for example, without receiving a mounting instruction from the robot control commanding unit 218. Specifically, the mounting robot 300 may realize motion of mounting a component on the vehicle 100 independently of an instruction from a different device. This embodiment also achieves effects comparable to those of the above-described embodiments.

(D7) In each of the above-described embodiments, the external sensor 250 is not limited to the camera but may be the distance measuring device, for example. The distance measuring device is a light detection and ranging (LiDAR) device, for example. In this case, detection result output from the external sensor 250 may be three-dimensional point cloud data representing the vehicle 100. The server 200 and the vehicle 100 may acquire the vehicle location information through template matching using the three-dimensional point cloud data as the detection result and reference point cloud data, for example.

(D8) In the above-described first embodiment, the server 200 performs the processing from acquisition of vehicle location information to generation of a running control signal. By contrast, the vehicle 100 may perform at least part of the processing from acquisition of vehicle location information to generation of a running control signal. For example, embodiments (1) to (3) described below are applicable, for example.

(1) The server 200 may acquire vehicle location information, determine a target location to which the vehicle 100 is to move next, and generate a route from a current location of the vehicle 100 indicated by the acquired vehicle location information to the target location. The server 200 may generate a route to the target location between the current location and a destination or generate a route to the destination. The server 200 may transmit the generated route to the vehicle 100. The vehicle 100 may generate a running control signal in such a manner as to cause the vehicle 100 to run along the route received from the server 200 and control an actuator using the generated running control signal.

(2) The server 200 may acquire vehicle location information and transmit the acquired vehicle location information to the vehicle 100. The vehicle 100 may determine a target location to which the vehicle 100 is to move next, generate a route from a current location of the vehicle 100 indicated by the received vehicle location information to the target location, generate a running control signal in such a manner as to cause the vehicle 100 to run along the generated route, and control an actuator using the generated running control signal.

(3) In the foregoing embodiments (1) and (2), an internal sensor may be mounted on the vehicle 100, and detection result output from the internal sensor may be used in at least one of the generation of the route and the generation of the running control signal. The internal sensor is a sensor mounted on the vehicle 100. The internal sensor includes, for example, a sensor that detects the state of motion of the vehicle 100, the state of operation of various parts of the vehicle 100, and the environment surrounding the vehicle 100. More specifically, the internal sensor might include a camera, LiDAR, a millimeter wave radar, an ultrasonic wave sensor, a GPS sensor, an acceleration sensor, and a gyroscopic sensor, for example. For example, in the foregoing embodiment (1), the server 200 may acquire detection result from the internal sensor, and in generating the route, may reflect the detection result from the internal sensor in the route. In the foregoing embodiment (1), the vehicle 100 may acquire detection result from the internal sensor, and in generating the running control signal, may reflect the detection result from the internal sensor in the running control signal. In the foregoing embodiment (2), the vehicle 100 may acquire detection result from the internal sensor, and in generating the route, may reflect the detection result from the internal sensor in the route. In the foregoing embodiment (2), the vehicle 100 may acquire detection result from the internal sensor, and in generating the running control signal, may reflect the detection result from the internal sensor in the running control signal.

(D9) In the third embodiment, the vehicle 100v may be equipped with an internal sensor, and detection result output from the internal sensor may be used in at least one of generation of a route and generation of a running control signal. For example, the vehicle 100v may acquire detection result from the internal sensor, and in generating the route, may reflect the detection result from the internal sensor in the route. The vehicle 100v may acquire detection result from the internal sensor, and in generating the running control signal, may reflect the detection result from the internal sensor in the running control signal.

(D10) In the above-described embodiment in which the vehicle 100 can be running by autonomous control, the vehicle 100 acquires vehicle location information using detection result from the external sensor. By contrast, the vehicle 100 may be equipped with an internal sensor, the vehicle 100 may acquire vehicle location information using detection result from the internal sensor, determine a target location to which the vehicle 100 is to move next, generate a route from a current location of the vehicle 100 indicated by the acquired vehicle location information to the target location, generate a running control signal for running along the generated route, and control an actuator of the vehicle 100 using the generated running control signal. In this case, the vehicle 100 is capable of running without using any detection result from an external sensor. The vehicle 100 may acquire target arrival time or traffic congestion information from outside the vehicle 100 and reflect the target arrival time or traffic congestion information in at least one of the route and the running control signal. The functional configuration of the system 10 may be entirely provided at the vehicle 100. Specifically, the processes realized by the system 10 in the present disclosure may be realized by the vehicle 100 alone. In this embodiment, it is judged whether a component has been mounted successfully on the vehicle 100 as follows. Using a status of connection between the component and a vehicle-mounted LAN, for example, if connection with a predetermined component has not been established at given timing, it is possible to determine that the on-the-move mounting of this component has not been conducted successfully.

(D11) In the above-described first embodiment, the server 200 automatically generates a running control signal to be transmitted to the vehicle 100. By contrast, the server 200 may generate a running control signal to be transmitted to the vehicle 100 in response to operation by an external operator existing outside the vehicle 100. For example, the external operator may operate an operating device including a display on which a captured image output from the external sensor 250 is displayed, steering, an accelerator pedal, and a brake pedal for operating the vehicle 100 remotely, and a communication device for making communication with the server 200 through wire communication or wireless communication, for example, and the server 200 may generate a running control signal responsive to the operation on the operating device.

(D12) The vehicle 100 may be manufactured by combining a plurality of modules. The module means a unit composed of one or more components grouped according to a configuration or function of the vehicle 100. For example, a platform of the vehicle 100 may be manufactured by combining a front module, a center module and a rear module. The front module constitutes a front part of the platform, the center module constitutes a center part of the platform, and the rear module constitutes a rear part of the platform. The number of the modules constituting the platform is not limited to three but may be equal to or less than two, or equal to or greater than four. In addition to or instead of the platform, any parts of the vehicle 100 different from the platform may be modularized. Various modules may include an arbitrary exterior component such as a bumper or a grill, or an arbitrary interior component such as a seat or a console. Not only the vehicle 100 but also any types of moving object may be manufactured by combining a plurality of modules. Such a module may be manufactured by joining a plurality of components by welding or using a fixture, for example, or may be manufactured by forming at least part of the module integrally as a single component by casting. A process of forming at least part of a module as a single component is also called Giga-casting or Mega-casting. Giga-casting can form each part conventionally formed by joining multiple parts in a moving object as a single component. The front module, the center module, or the rear module described above may be manufactured using Giga-casting, for example.

(D13) Conveying the vehicle 100 using running of the vehicle 100 by unmanned driving is also called “self-running conveyance.” A configuration for realizing self-running conveyance is also called a “Remote Control auto Driving system. Producing the vehicle 100 using self-running conveyance is also called “self-running production.” In self-running production, for example, at least part of the conveyance of the vehicle 100 is realized by self-running conveyance in the factory KJ where the vehicle 100 is manufactured.

(D14) A configuration for realizing running of the vehicle 100 by unmanned driving is also called a “Remote Control auto Driving system”. Conveying the vehicle 100 using Remote Control Auto Driving system is also called “self-running conveyance”. Producing the vehicle 100 using self-running conveyance is also called “self-running production”. In self-running production, for example, at least part of the conveyance of the vehicle 100 is realized by self-running conveyance in a factory where the vehicle is manufactured.

The present disclosure is not limited to the above-described embodiments but is feasible in various configurations within a range not deviating from the purport of the disclosure. For example, technical features in the embodiments corresponding to those in each of the aspects described in SUMMARY may be replaced or combined, where appropriate, with the intention of solving some or all of the aforementioned problems or achieving some or all of the aforementioned effects. Unless being described as absolute necessities in the present specification, these technical features may be deleted, where appropriate. The present disclosure may be realized in the following aspects, for example.

(1) According to one aspect of the present disclosure, a control device is provided that controls mounting of a component on a moving object in the process of manufacturing the moving object. The control device comprises: an information acquiring unit that acquires first information that is information relating to unsuccessful mounting of the component by a mounting device to conduct on-the-move mounting that is mounting of the component on the moving object while the moving object is moving by unmanned driving; a first instructing unit that gives a first instruction for instructing deceleration or stop to the moving object if the first information is acquired; and a second instructing unit that gives a second instruction for instructing re-mounting to the mounting device after transmission of the first instruction. The re-mounting is mounting of the component on the moving object while the moving object is decelerated or stopped.

According to the control device of this aspect, if the component has not been mounted successfully on the moving object by the on-the-move mounting, the first instruction for instructing deceleration or stop is transmitted to the moving object, and the second instruction for instructing the re-mounting is transmitted to the mounting device. Thus, even if the component has not been mounted successfully on the moving object by the on-the-move mounting, it is still possible to attempt the re-mounting of the component while a difficulty level in component mounting is reduced by decelerating or stopping the moving object. By doing so, it becomes possible to mount the component properly on the moving object.

(2) In the above-described aspect, the first instructing unit may further instruct a following moving object to be decelerated or stopped if the first information is acquired. The following moving object is a different moving object moving behind the moving object.

According to the control device of this aspect, if the on-the-move mounting has not been conducted successfully, the following moving object is instructed to be decelerated or stopped. This makes it possible to suppress shortening of a distance between the moving object on which the on-the-move mounting has not been conducted successfully and the following moving object.

(3) In the above-described aspect, if the component has been mounted successfully on the moving object by the re-mounting, the control device may further instruct the moving object to be accelerated or restart moving.

According to the control device of this aspect, moving is restarted or accelerated if the component has been mounted successfully by the re-mounting control. This makes it possible to suppress extension of time required for manufacturing the moving object, compared to a case where the decelerated or stopped state is kept continuously.

(4) In the above-described aspect, if the component has not been mounted successfully on the moving object by the re-mounting, the first instructing unit may further perform at least one of: instructing the moving object to continue a decelerated or stopped state; and instructing a following moving object to be decelerated or stopped. The following moving object is a different moving object moving behind the moving object.

According to the control device of this aspect, if the component has not been mounted successfully on the moving object by the re-mounting, at least one of instructing the moving object to continue a decelerated or stopped state and instructing a following moving object to be decelerated or stopped is performed further. The following moving object is a different moving object moving behind the moving object. Thus, it is possible to restrict moving of the moving object or the following moving object in a situation where the re-mounting has not been conducted successfully, namely, in a situation where some type of abnormality might occur.

(5) In the above-described aspect, the control device may further comprise a motion control signal generating unit that generates a motion control signal for causing the mounting device to make motion, and the second instructing unit may transmit the motion control signal as the second instruction to the mounting device.

According to the control device of this aspect, as the control device generates the motion control signal and transmits the motion control signal to the mounting device, it is possible to prevent the control on the side of the mounting device from growing complicated.

(6) According to another aspect of the present disclosure, a system is provided. The system comprises: the control device described in any one of the first to fourth aspects; and the mounting device. The mounting device includes: a receiving unit that receives the second instruction; a motion control signal generating unit that receives the second instruction and generates a motion control signal for causing the mounting device to make motion; and a device controller that controls the motion of the mounting device in response to the motion control signal.

According to the system of this aspect, as the mounting device generates the motion control signal, it is possible to prevent the control on the side of the control device from growing complicated.

(7) According to another aspect of the present disclosure, a mounting device that mounts a component on a moving object is provided. The mounting device comprises a device controller that conducts re-mounting if the component has not been mounted successfully on the moving object while the moving object is moving by unmanned driving. The re-mounting is mounting of the component on the moving object while the moving object is decelerated or stopped.

According to the mounting device of this aspect, even if the component has not been mounted successfully on the moving object by the on-the-move mounting, it is still possible to attempt the re-mounting of the component on the moving object while the moving object is at a difficulty level in component mounting reduced by decelerating or stopping the moving object. By doing so, it becomes possible to mount the component properly on the moving object.

(8) In the above-described aspect, the mounting device may comprise a motion control signal generating unit that generates a motion control signal for causing the mounting device to make motion, and the device controller may conduct the re-mounting in response to the motion control signal generated by the motion control signal generating unit.

According to the mounting device of this aspect, as the mounting device generates the motion control signal, it is possible to prevent the control on the side of the control device from growing complicated.

(9) According to another aspect of the present disclosure, a moving object is provided that is movable by unmanned driving in a process of manufacturing the moving object. The moving object comprises a moving object controller that performs: deceleration or stopping if on-the-move mounting has not been conducted successfully, the on-the-move mounting being mounting of a component on the moving object while the moving object is moving by the unmanned driving; and acceleration or restart of moving if the component has been mounted successfully on the moving object by re-mounting that is mounting of the component on the moving object while the moving object is decelerated or stopped.

According to the moving object of this aspect, even if the component has not been mounted successfully on the moving object by the on-the-move mounting, it is still possible to attempt the re-mounting of the component while a difficulty level in component mounting is reduced by the deceleration or stopping. By doing so, it becomes possible to mount the component properly on the moving object.

What is claimed is:

1. A control device that controls mounting of a component on a moving object in a process of manufacturing the moving object, the control device comprising:
an information acquiring unit that acquires first information that is information relating to unsuccessful mounting of the component by a mounting device to conduct on-the-move mounting that is mounting of the component on the moving object while the moving object is moving by unmanned driving;
a first instructing unit that gives a first instruction for instructing deceleration or stop to the moving object if the first information is acquired; and
a second instructing unit that gives a second instruction for instructing re-mounting to the mounting device after transmission of the first instruction, the re-mounting being mounting of the component on the moving object while the moving object is decelerated or stopped.

2. The control device according to claim 1, wherein
the first instructing unit further instructs a following moving object to be decelerated or stopped if the first information is acquired, the following moving object being a different moving object moving behind the moving object.

3. The control device according to claim 1, wherein
if the component has been mounted successfully on the moving object by the re-mounting, the control device further instructs the moving object to be accelerated or restart moving.

4. The control device according to claim 1, wherein
if the component has not been mounted successfully on the moving object by the re-mounting, the first instructing unit further performs at least one of:
instructing the moving object to continue a decelerated or stopped state; and
instructing a following moving object to be decelerated or stopped, the following moving object being a different moving object moving behind the moving object.

5. The control device according to claim 1, further comprising:
a motion control signal generating unit that generates a motion control signal for causing the mounting device to make motion, wherein
the second instructing unit transmits the motion control signal as the second instruction to the mounting device.

6. The control device according to claim 4, further comprising:
a motion control signal generating unit that generates a motion control signal for causing the mounting device to make motion, wherein
the second instructing unit transmits the motion control signal as the second instruction to the mounting device.

7. A system comprising:
the control device according to claim 1; and
the mounting device, wherein
the mounting device includes:
a receiving unit that receives the second instruction;
a motion control signal generating unit that receives the second instruction and generates a motion control signal for causing the mounting device to make motion; and
a device controller that controls the motion of the mounting device in response to the motion control signal.

8. A system comprising:
the control device according to claim 4; and
the mounting device, wherein
the mounting device includes:
a receiving unit that receives the second instruction;
a motion control signal generating unit that receives the second instruction and generates a motion control signal for causing the mounting device to make motion; and
a device controller that controls the motion of the mounting device in response to the motion control signal.

9. A mounting device that mounts a component on a moving object, comprising:
a device controller that conducts re-mounting if the component has not been mounted successfully on the moving object while the moving object is moving by unmanned driving, the re-mounting being mounting of the component on the moving object while the moving object is decelerated or stopped.

10. The mounting device according to claim 9, comprising:
a motion control signal generating unit that generates a motion control signal for causing the mounting device to make motion, wherein
the device controller conducts the re-mounting in response to the motion control signal generated by the motion control signal generating unit.

11. A moving object movable by unmanned driving in a process of manufacturing the moving object, the moving object comprising:
a moving object controller that performs:
deceleration or stopping if on-the-move mounting has not been conducted successfully, the on-the-move mounting being mounting of a component on the moving object while the moving object is moving by the unmanned driving; and
acceleration or restart of moving if the component has been mounted successfully on the moving object by re-mounting that is mounting of the component on the moving object while the moving object is decelerated or stopped.
